(19) United States
(12) Patent Application Publication
(10) Pub. No.: US 2024/0088834 A1
(43) Pub. Date: Mar. 14, 2024

(54) METHOD, DEVICE, AND SYSTEM FOR MONITORING PHOTOVOLTAIC POWER STATION

(71) Applicants: ENVISION DIGITAL iNTERNATIONAL PTE. LTD., Singapore (SG); SHANGHAI ENVISION DIGITAL CO., LTD., Shanghai (CN)

(72) Inventors: Xiang LI, Shanghai (CN); Biyun LIU, Shanghai (CN); Wenci REN, Shanghai (CN); Liming LUO, Shanghai (CN)

(73) Assignees: ENVISION DIGITAL INTERNATIONAL PTE. LTD, Singapore (SG); SHANGHAI ENVISION DIGITAL CO., LTD., Shanghai (CN)

(21) Appl. No.: 18/286,391

(22) PCT Filed: Apr. 12, 2022
(86) PCT No.: PCT/SG2022/050209

§ 371 Date: Oct. 11, 2023

(30) Foreign Application Priority Data
Apr. 15, 2021 (CN) 202110408034.4

(51) Int. Cl. H02S 50/10

(52) U.S. Cl. CPC H02S 50/10

(57) ABSTRACT

Disclosed are a method, device, and system for monitoring a photovoltaic power station. The device for monitoring the photovoltaic power station may display prompt information with respect to a first photovoltaic device on a display of the device in response to determining, based on the operation data of the first photovoltaic device, that the first photovoltaic device operates abnormally. Thus, a monitoring engineer may judge whether the first photovoltaic device is faulty in time based on the prompt information, facilitating the guide of subsequent operation and maintenance according to the operation data of the photovoltaic device, which not only is higher in flexibility but also ensures the efficiency of fault detection. In addition, the device may further send operation and maintenance information to an operation and maintenance terminal in response to detecting an acknowledge operation with respect to the prompt information, such that the efficiency of overhauling a faulty photovoltaic device may be effectively improved.

### TECHNICAL FIELD

The present disclosure relates to the field of photovoltaic power station technologies, and in particular, relates to a method, device, and system for monitoring a photovoltaic power station.

### BACKGROUND

With the continuous development of the Internet of things (IoT) and digital technologies, various systems for monitoring photovoltaic power stations are widely used in the monitoring and operation and maintenance processes of photovoltaic power stations.

In the related art, a photovoltaic power station includes a variety of photovoltaic devices, such as a booster station, an inverter, and a combiner box. The system for monitoring the photovoltaic power station may monitor the operation data of the photovoltaic device during the operation of the photovoltaic device. Then, the monitoring engineer may determine, based on the operation data monitored by the monitoring system, whether the photovoltaic device is faulty, and notify the operation and maintenance engineer when the photovoltaic device fails, such that the operation and maintenance engineer may overhaul the photovoltaic device in the photovoltaic power station.

However, since the system for monitoring the photovoltaic power station only has the function of monitoring the operation data of the photovoltaic device in the photovoltaic power station, the flexibility of the system for monitoring the photovoltaic power station is poor.

### SUMMARY

Embodiments of the present disclosure provide a method, device, and system for monitoring a photovoltaic power station, which may solve the problem of poor flexibility of the system for monitoring the photovoltaic power station in the related art.

In one aspect, a method for monitoring a photovoltaic power station is provided. The method is applicable to a device for monitoring the photovoltaic power station, wherein the photovoltaic power station includes a plurality of photovoltaic devices.

The method includes: acquiring operation data of each of the plurality of photovoltaic devices; displaying prompt information with respect to a first photovoltaic device in response to determining, based on the operation data of the first photovoltaic device, that the first photovoltaic device operates abnormally; and sending operation and maintenance information to an operation and maintenance terminal in response to an acknowledge operation with respect to the prompt information, wherein the operation and maintenance information is a prompt to overhaul the first photovoltaic device.

In some embodiments, displaying prompt information with respect to the first photovoltaic device in response to determining, based on the operation data of the first photovoltaic device, that the first photovoltaic device operates abnormally includes: displaying an identification of the first photovoltaic device according to a first display effect in response to determining, based on the operation data of the first photovoltaic device, that the first photovoltaic device operates abnormally; wherein the first display effect is different from a second display effect of identifications of other normal photovoltaic devices.

In some embodiments, upon displaying the identification of the first photovoltaic device according to the first display effect, the method further includes: displaying alarm information for the first photovoltaic device, and displaying an identification of each of second photovoltaic devices associated with the first photovoltaic device, in response to a select operation with respect to the identification of the first photovoltaic device, wherein the alarm information includes abnormal operation data of the first photovoltaic device.

In some embodiments, prior to displaying the prompt information with respect to the first photovoltaic device, the method further includes: displaying a map of the photovoltaic power station, wherein the map includes identification of at least one of the photovoltaic devices; and displaying the identification of each of the second photovoltaic devices associated with the first photovoltaic device includes: displaying a target area in the map according to a target scaling, wherein the target area includes the identification of the first photovoltaic device and the identification of each of the second photovoltaic devices, wherein the target scaling is determined based on a distance between the first photovoltaic device and each of the second photovoltaic devices and a resolution of a display of the device for monitoring the photovoltaic power station, the target scaling is positively related to the distance and negatively related to the resolution.

In some embodiments, the photovoltaic power station includes a plurality of device groups of different levels, each of the device groups including one photovoltaic device or a plurality of photovoltaic devices of the same level; and displaying the map of the photovoltaic power station includes: displaying the map of the photovoltaic power station according to an initial scaling, wherein the map includes identification of at least one of the first photovoltaic device and a photovoltaic device with a level higher than a level threshold.

In some embodiments, displaying the identification of the first photovoltaic device according to the first display effect includes: determining an abnormality level of the first photovoltaic device based on the operation data of the first photovoltaic device; and displaying the identification of the first photovoltaic device according to a color corresponding to the abnormality level; wherein different colors correspond to different abnormality levels.

In some embodiments, the method further includes: displaying the identification of the third photovoltaic device according to a third display effect in response to the selection operation of the identification of the first photovoltaic device; wherein the third display effect is different from the first display effect and the second display effect, and the third photovoltaic device is a photovoltaic device of the plurality of photovoltaic devices other than first photovoltaic device and the second photovoltaic device.

In some embodiments, upon displaying the prompt information with respect to the first photovoltaic device, the method further includes:
adjusting a display effect of the identification of the first photovoltaic device to the second display effect in response to determining, based on reacquired operation data of the first photovoltaic device, that the first photovoltaic device resumes normal operation.

In another aspect, a device for monitoring a photovoltaic power station is provided. The photovoltaic power station includes a plurality of photovoltaic devices.

The device includes: an acquiring module, configured to acquire operation data of each of the plurality of photovoltaic devices; a displaying module, configured to display prompt information with respect to a first photovoltaic device in response to determining, based on the operation data of the first photovoltaic device, that the first photovoltaic device operates abnormally; a sending module, configured to send operation and maintenance information to an operation and maintenance terminal in response to acknowledge operation with respect to the prompt information, wherein the operation and maintenance information is a prompt to overhaul the first photovoltaic device.

In some embodiments, the displaying module is further configured to display an identification of a first photovoltaic device according to a first display effect in response to determining, based on the operation data of the first photovoltaic device, that the first photovoltaic device operates abnormally;
wherein the first display effect is different from a second display effect of identifications of other normal photovoltaic devices.

In some embodiments, the displaying module is further configured to display alarm information for the first photovoltaic device and display an identification of each of second photovoltaic devices associated with the first photovoltaic device, in response to a select operation with respect to the identification of the first photovoltaic device, wherein the alarm information includes abnormal operation data of the first photovoltaic device.

In some embodiments, the displaying module is further configured to display a map of the photovoltaic power station, wherein the map includes identification of at least one of the photovoltaic devices; and the displaying module is further configured to display a target area in the map according to a target scaling, wherein the target area includes an identification of the first photovoltaic device and an identification of each of the second photovoltaic devices, wherein the target scaling is determined based on a distance between the first photovoltaic device and each of the second photovoltaic devices and a resolution of a display of the device for monitoring the photovoltaic power station, the target scaling is positively related to the distance and negatively related to the resolution.

In some embodiments, the photovoltaic power station includes a plurality of device groups of different levels, each of the device groups including one photovoltaic device or a plurality of photovoltaic devices of same level; and the displaying module is further configured to: display the map of the photovoltaic power station according to an initial scaling, wherein the map includes identification of at least one of the first photovoltaic device and a photovoltaic device with a level higher than a level threshold.

In some embodiments, the displaying module is further configured to: determine an abnormality level of the first photovoltaic device based on the operation data of the first photovoltaic device; display the identification of the first photovoltaic device according to a color corresponding to the abnormality level; wherein different colors correspond to different abnormality levels.

In some embodiments, the displaying module is further configured to display an identification of a third photovoltaic device according to a third display effect in response to the selection operation of the identification of the first photovoltaic device; wherein the third display effect is different from the first display effect and the second display effect, and the third photovoltaic device is a photovoltaic device of the plurality of photovoltaic devices other than first photovoltaic device and the second photovoltaic device.

In some embodiments, the device further includes an adjusting module configured to adjust a display effect of the identification of the first photovoltaic device to the second display effect in response to determining, based on reacquired operation data of the first photovoltaic device, that the first photovoltaic device resumes normal operation.

In yet another aspect, a system for monitoring a photovoltaic power station is provided. The system for monitoring includes an operation and maintenance device and the device for monitoring the photovoltaic power station according to the above aspect; wherein the device is in communication with the operation and maintenance device.

In still another aspect, a device for monitoring a photovoltaic power station is provided. The device includes a processor, a memory, and a computer program stored on the memory and executable on the processor; wherein the processor, when loading and executing the computer program, is caused to perform the method for monitoring the photovoltaic power station according to the above aspect.

In another aspect, a computer-readable storage medium storing one or more instructions therein is provided. The one or more instructions, when loaded and executed by a processor of a computer, cause the computer to perform the method for monitoring the photovoltaic power station according to the above aspect.

In yet another aspect, a computer program product including one or more instructions therein is provided. The one or more instructions, when loaded and executed by a processor of a computer, cause the computer to perform the method for monitoring the photovoltaic power station according to the above aspect.

The technical solutions according to the present disclosure at least achieve the following beneficial effects.

The device for monitoring the photovoltaic power station may display prompt information with respect to a first photovoltaic device on a display of the device for monitoring the photovoltaic power station in response to determining, based on the operation data of the first photovoltaic device, that the first photovoltaic device operates abnormally. Thus, a monitoring engineer may judge whether the first photovoltaic device is faulty in time based on the prompt information, facilitating the guide of subsequent operation and maintenance work according to the operation data of the photovoltaic device, which not only is higher in flexibility but also ensures the efficiency of fault detection. In addition, the device for monitoring the photovoltaic power station may further send operation and maintenance information to an operation and maintenance terminal in response to detecting an acknowledge operation with respect to the prompt information, therefore the efficiency of overhauling a faulty photovoltaic device may be effectively improved.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic structural diagram of a monitoring system according to some embodiments of the present disclosure;

FIG. 2 is a flowchart of a method for monitoring a photovoltaic power station according to some embodiments of the present disclosure;

FIG. 3 is a flowchart of another method for monitoring a photovoltaic power station according to some embodiments of the present disclosure;

FIG. 4 is a schematic diagram of a plurality of device groups according to some embodiments of the present disclosure;

FIG. 5 is a schematic diagram of another plurality of device groups according to some embodiments of the present disclosure;

FIG. 6 is a schematic diagram of a device distribution interface according to some embodiments of the present disclosure;

FIG. 7 is a schematic diagram of types of the photovoltaic devices and icons of the photovoltaic devices according to some embodiments of the present disclosure;

FIG. 8 is a schematic diagram of a monitoring interface according to some embodiments of the present disclosure;

FIG. 9 is a flowchart of displaying an identification of a first photovoltaic device according to some embodiments of the present disclosure;

FIG. 10 is a schematic diagram of another device distribution interface according to some embodiments of the present disclosure;

FIG. 11 is a schematic diagram of a device monitoring interface according to some embodiments of the present disclosure;

FIG. 12 is a schematic diagram of an alarm interface according to some embodiments of the present disclosure;

FIG. 13 is a schematic diagram of a power station monitoring interface according to some embodiments of the present disclosure;

FIG. 14 is a schematic diagram of an operation and maintenance interface according to some embodiments of the present disclosure;

FIG. 15 is a schematic diagram of another operation and maintenance interface according to some embodiments of the present disclosure;

FIG. 16 is a schematic diagram of yet another operation and maintenance interface according to some embodiments of the present disclosure;

FIG. 17 is a schematic structural diagram of a monitoring device according to some embodiments of the present disclosure; and

FIG. 18 is a schematic structural diagram of another monitoring device according to some embodiments of the present disclosure.

### DETAILED DESCRIPTION

For clearer descriptions of the objectives, technical solutions, and advantages of the present disclosure, embodiments of the present disclosure are described in detail hereinafter with reference to the accompanying drawings.

With the continuous development of the IoT and digital technologies, various systems for monitoring a photovoltaic power station emerge endlessly. The system for monitoring a photovoltaic power station has become an indispensable part of the monitoring and the operation and maintenance processes of a centralized or distributed photovoltaic power station, and plays an increasingly important role.

During the operation and maintenance of the photovoltaic power station, the operation and maintenance workers often face problems of being unable to determine the position of the faulty photovoltaic device and being unclear about the connection relationship between various photovoltaic devices and the like. These problems may lead to low operation and maintenance efficiency of the photovoltaic power station, and long-term fault of the photovoltaic device. As a result, the loss of power generation amount of the photovoltaic power station is relatively large, and there may be potential safety hazards, such as fire.

In the related art, the system for monitoring the photovoltaic power station only has the functions of monitoring the operation data of the photovoltaic device in the photovoltaic power station and displaying the operation data sent by the photovoltaic device, which may thus lead to really valuable data (for example, operation data of potentially faulty photovoltaic device) is submerged in a large amount of data. The monitoring engineer may not judge the operation status of the photovoltaic device in time, and thus may not guide the operation and maintenance worker to overhaul the photovoltaic device.

In addition, even in the case that the monitoring engineer judges, based on the operation data sent by the photovoltaic device, that the photovoltaic device is faulty, the actual operation and maintenance of the operation and maintenance engineer still needs to be made rely on the experience of the operation and maintenance engineer and the construction drawings of the photovoltaic power station. That is, the system for monitoring the photovoltaic power station is not combined with the actual operation and maintenance process of the photovoltaic power station. With the development of geographic information system (GIS) and other technologies, it is a future development trend to digitize the operation data of various photovoltaic devices in the photovoltaic power station and then guide the operation and maintenance of the photovoltaic power station by data integration.

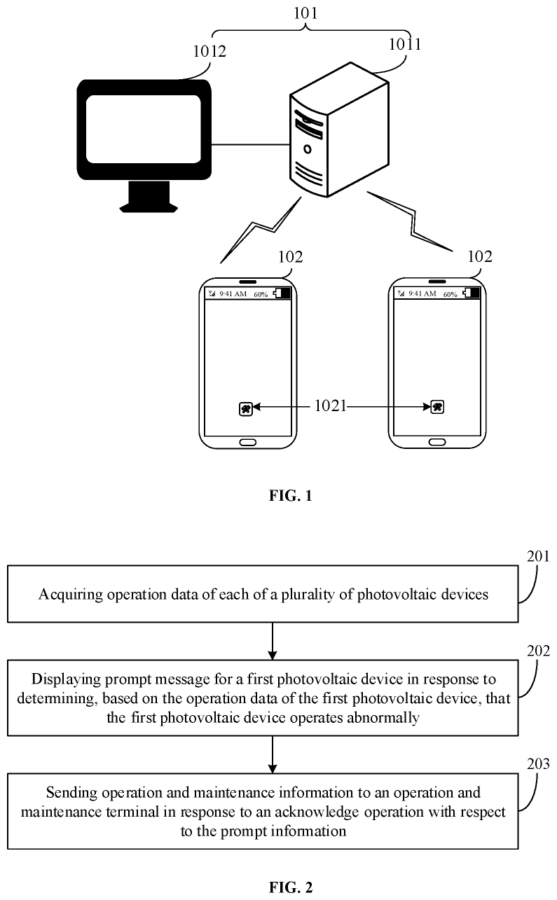

FIG. 1 is a schematic structural diagram of a system for monitoring a photovoltaic power station according to some embodiments of the present disclosure. Referring to FIG. 1, the monitoring system 10 may include: a monitoring device 101, and one or more operation and maintenance terminals 102. For example, two operation and maintenance terminals 102 are shown in FIG. 1. Each of the operation and maintenance terminals 102 may be installed with an operation and maintenance client (the client may also be referred to as an application) 1021. The monitoring device 101 may be in communication with each operation and maintenance terminal 102 over a wired or wireless network.

The operation and maintenance terminal 102 may be a smart phone, a computer, or a tablet computer, or the like. As shown in FIG. 1, the monitoring device 101 may include a host 1011 and a display 1012. The host 1011 may be a server, or a server cluster composed of several servers, or a cloud computing service center. The display 1012 is used to display the operation data of the photovoltaic device in the photovoltaic power station.

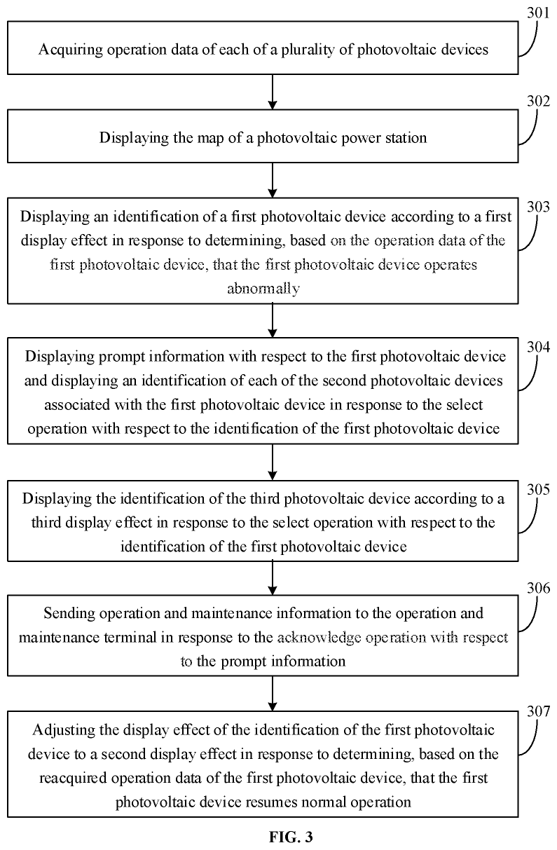

FIG. 2 is a flowchart of a method for monitoring a photovoltaic power station according to some embodiments of the present disclosure. The method is applicable to the monitoring device 101 shown in FIG. 1. With reference to FIG. 2, the method may include the following steps.

In step 201, the monitoring device acquires operation data of each of a plurality of photovoltaic devices.

In embodiments of the present disclosure, the photovoltaic power station may include a plurality of photovoltaic devices, and each of the photovoltaic devices may send operation data to the monitoring device 101 during operation. Thus, the monitoring device 101 may acquire the operation data of each photovoltaic device during operation. For example, the operation data of the photovoltaic device may include data of at least one of the following operation indicators: device power, temperature, power generation amount, and power generation efficiency.

In step 202, the monitoring device displays prompt information with respect to a first photovoltaic device is displayed in response to determining, based on the operation data of the first photovoltaic device, that the first photovoltaic device operates abnormally.

In embodiments of the present disclosure, the monitoring device 101 may pre-store threshold ranges each corresponding to one of the operation indicators. For each operation indicator of each of the photovoltaic devices, the monitoring device 101 may determine, based on the obtained data of the operation indicator and the pre-stored threshold range of the operation indicator, whether the data of the operation indicator of the photovoltaic device is within the threshold range. In the case that the data of each of the plurality of operation indicators is within the corresponding threshold range, the monitoring device 101 may determine that the operation data of the photovoltaic device is normal, and further determine that the photovoltaic device operates normally. In the case that data of operation indicators of the plurality of operation indicators is not within the corresponding threshold range, the monitoring device 101 may determine that the operation data of the photovoltaic device is abnormal, and further determine that the photovoltaic device operates abnormally.

In some embodiments, in the case that the monitoring device 101 determines, based on the operation data of the first photovoltaic device, that the first photovoltaic device operates abnormally, the display 1012 of the monitoring device 101 may display the prompt information with respect to the first photovoltaic device. The prompt information may remind that the monitoring engineer that the first photovoltaic device may be faulty at present.

In step 203, the monitoring device sends operation and maintenance information to an operation and maintenance terminal in response to the acknowledge operation with respect to the prompt information.

In embodiments of the present disclosure, upon receiving the prompt information with respect to the first photovoltaic device over the display 1012 of the monitoring device 101, the monitoring engineer may know that the first photovoltaic device may be faulty at present. The monitoring engineer may further judge, based on the operation data of the first photovoltaic device, whether the abnormal operation data of the first photovoltaic device is caused by the fault of the first photovoltaic device.

In the case that the monitoring engineer judges, based on the operation data of the first photovoltaic device, that the first photovoltaic device is faulty, the monitoring engineer may trigger the acknowledge operation with respect to the prompt information. Upon receiving the acknowledge operation with respect to the prompt information, the monitoring device 101 may send the operation and maintenance information to the operation and maintenance terminal 102. The operation and maintenance information is a prompt to overhaul the first photovoltaic device. Thus, the operation and maintenance engineer may review the operation and maintenance information sent by the monitoring device 101 over the operation and maintenance terminal 102, and the operation and maintenance engineer may overhaul the first photovoltaic device based on the operation and maintenance information. The operation and maintenance information may be an operation and maintenance work order.

In the case that the monitoring engineer judges, based on the operation data of the first photovoltaic device, that the abnormal operation data of the first photovoltaic device is only caused by external environmental factors (for example, the shadow from the tree or building blocking the first photovoltaic device), the first photovoltaic device is not faulty, the monitoring engineer may trigger the cancellation for the prompt information. Upon receiving the cancellation for the prompt information, the monitoring device 101 may determine that the operation and maintenance information does not need to be sent to the operation and maintenance terminal 102. That is, the monitoring device 101 may ignore the prompt information.

In summary, the embodiments of the present disclosure provide a method for monitoring a photovoltaic power station. The device for monitoring the photovoltaic power station may display the prompt information with respect to the first photovoltaic device on the display of the device in response to determining, based on the operation data of the first photovoltaic device, that the first photovoltaic device operates abnormally. Therefore, the monitoring engineer may timely judge, based on the prompt information, whether the first photovoltaic device is faulty, which is convenient for the monitoring engineer to guide the subsequent operation and maintenance based on the operation data of the photovoltaic device, which not only has better flexibility, but also ensures the efficiency of fault detection. Moreover, since the monitoring device may also send the operation and maintenance information to the operation and maintenance terminal in response to detecting the acknowledge operation with respect to the prompt information, the efficiency of overhauling the faulty photovoltaic device may be effectively improved.

FIG. 3 is a flowchart of another method for monitoring a photovoltaic power station according to some embodiments of the present disclosure. This method is applicable to the monitoring device 101 shown in FIG. 1. With reference to FIG. 3, the method may include the following steps.

In step 301, the monitoring device acquires operation data of each of a plurality of photovoltaic devices.

In embodiments of the present disclosure, the photovoltaic power station may include a plurality of photovoltaic devices, and each of the photovoltaic devices may send operation data to the monitoring device 101 during operation. Thus, the monitoring device 101 acquires the operation data of each photovoltaic device during operation. For example, the operation data of the photovoltaic device may include data of at least one of the following operation indicators: device power, temperature, power generation amount, and power generation efficiency.

In some embodiments, the plurality of photovoltaic devices included in the photovoltaic power station may be categorized into a plurality of device groups of different levels, and each device group includes one photovoltaic device or a plurality of photovoltaic devices of the same level. The types of photovoltaic devices included in the device groups of different levels may be the same or different.

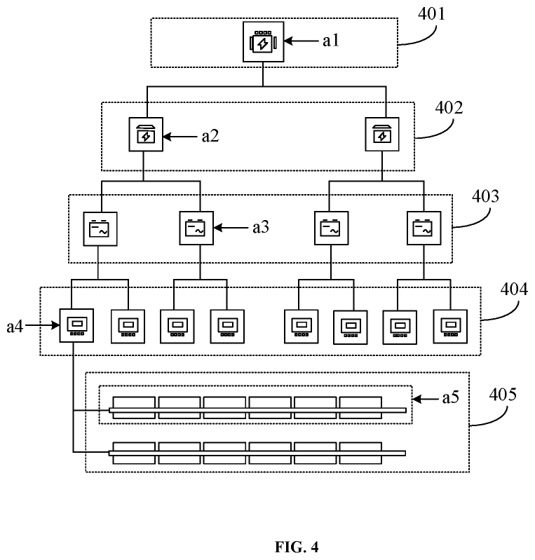

For example, referring to FIG. 4, the plurality of photovoltaic devices may be categorized into a first device group 401, a second device group 402, a third device group 403, a fourth device group 404, and a fifth device group 405. The first level of the first device group 401 is higher than the second level of the second device group 402. The second level of the second device group 402 is higher than the third level of the third device group 403. The third level of the third device group 403 is higher than the fourth level of the fourth device group 404. The fourth level of the fourth device group 404 is higher than the fifth level of the fifth device group 405.

In one optional embodiment, referring to FIG. 4, the first device group 401 includes a booster station a1. The second device group 402 includes a plurality of box-type substations a2, and each of the box-type substations a2 is connected to the booster station a1 in the first device group 401. The third device group 403 includes a plurality of inverters a3, wherein each of the inverters a3 is connected to one box-type substation a2, and each of the box-type substations a2 may be connected to at least one inverter a3. The fourth device group 404 includes a plurality of combiner boxes a4, wherein each of the combiner boxes a4 is connected to one inverter a3, and one inverter a3 may be connected to at least one combiner box a4. The fifth device group 405 includes a plurality of strings a5, wherein each of the strings a5 may be connected to one combiner box a4, and one combiner box a4 may be connected to at least one string a5. Each of the strings a5 may be formed by connecting multiple assemblies in series, and the assemblies may be solar cells. The inverter a3 may be a centralized inverter, and the combiner box a4 may be a DC combiner box.

The level of the booster station a1 included in the first device group 401 is higher than the level of the box-type substations a2 included in the second device group 402. The level of the box-type substations a2 included in the second device group 402 is higher than the level of the inverters a3 included in the third device group 403. The level of the inverters a3 included in the third device group 403 is higher than the level of the combiner boxes a4 included in the fourth device group 404. The level of the combiner boxes a4 included in the fourth device group 404 is higher than the level of the strings a5 included in the fifth device group 405.

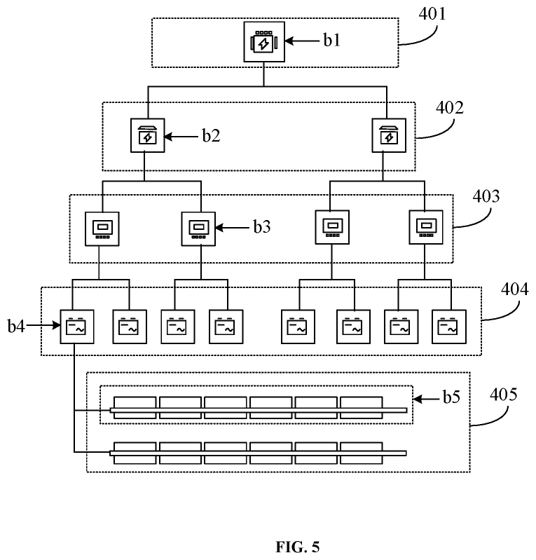

In another optional embodiment, referring to FIG. 5, the first device group 401 includes one booster station b1. The second device group 402 includes a plurality of box-type substations b2, wherein each of the box-type substations b2 is connected to the booster station b1 in the first device group 401. The third device group 403 includes a plurality of combiner boxes b3, wherein each of the combiner boxes b3 is connected to one box-type substation b2, and each of the box-type substations b2 may be connected to at least one combiner box b3. The fourth device group may include a plurality of inverters b4, each inverter b4 is connected to one combiner box b3, and one combiner box b3 may be connected to at least one inverter b4. The fifth device group 405 includes a plurality of strings b5, wherein each of the strings b5 may be connected to one inverter b4, and one inverter b4 may be connected to the plurality of strings b5. Each of the strings b5 may be formed by connecting multiple assemblies in series, and the assemblies may be solar cells. The inverter b4 may be a string inverter, and the combiner box b3 may be an AC combiner box.

The level of the booster station b1 included in the first device group 401 is higher than the level of the box-type substations b2 included in the second device group 402. The level of the box-type substations b2 included in the second device group 402 is higher than the level of the combiner boxes b3 included in the third device group 403. The level of the combiner boxes b3 included in the third device group 403 is higher than the level of the inverters b4 included in the fourth device group 404. The level of the inverters b4 included in the fourth device group 404 is higher than the level of the strings b5 included in the fifth device group 405.

In still another optional embodiment, the first device group 401 includes one booster station. The second device group 402 includes a plurality of box-type substations, wherein each of the box-type substations is connected to the booster station in the first device group 401. The third device group 403 includes a plurality of combiner boxes and a plurality of inverters, wherein each of the combiner boxes and each of the inverters are connected to one box-type substation, and each box-type substation may be connected to at least one combiner box or at least one inverter. The fourth device group 404 includes a plurality of combiner boxes and a plurality of inverters. Each of the combiner boxes in the fourth device group 404 is connected to one inverter in the third device group 403, and each of the inverters in the third device group 403 is connected to at least one combiner box of the fourth device group 404. Each of the inverters in the fourth device group 404 is connected to one combiner box in the third device group 403, and each of the combiner boxes in the third device group 403 is connected to at least one inverter of the fourth device group 404. The fifth device group 405 includes a plurality of strings, wherein each of the strings is connected to one combiner box of the fourth device group 404 or to one inverter of the fourth device group 404. Both of each of the combiner boxes and each of the inverters in the fourth device group 404 may be connected to at least one string. Each of the strings may be formed by connecting multiple assemblies in series, and the assemblies may be solar cells. The inverters in the third device group 403 may be centralized inverters, and the combiner boxes in the third device group 403 may be DC combiner boxes. The inverters in the fourth device group 404 may be string inverters, and the combiner boxes in the fourth device group 404 may be AC combiner boxes.

The level of the booster station included in the first device group 401 is higher than the level of the box-type substations included in the second device group 402. The level of the box-type substations included in the second device group 402 is higher than the levels of the combiner boxes and the inverters included in the third device group 403. The levels of the combiner boxes and the inverters included in the third device group 403 are higher than the levels of the combiner boxes and the inverters included in the fourth device group 404. The levels of the combiner boxes and inverters included in the fourth device group 404 are higher than the level of the strings included in the fifth device group 405.

In step 302, the monitoring device displays a map of the photovoltaic power station.

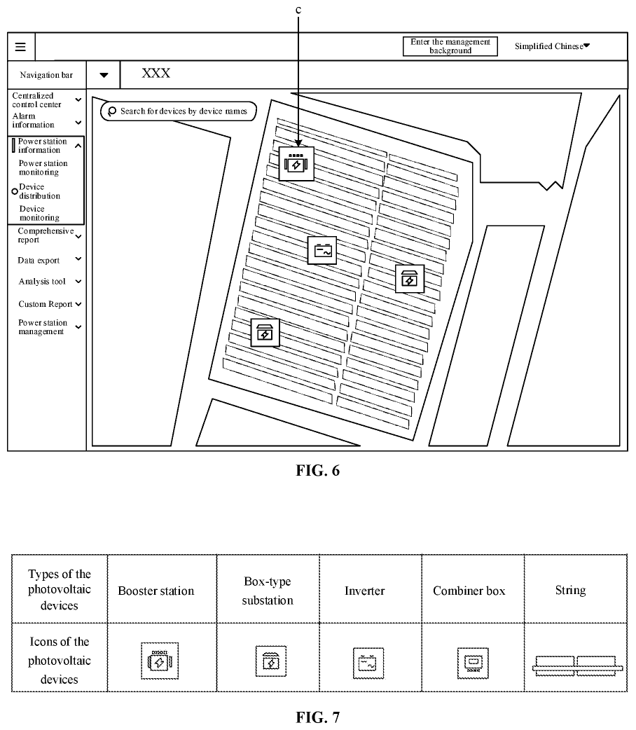

In the embodiments of the present disclosure, referring to FIG. 6, in the process of acquiring the operation data of the photovoltaic device, the monitoring device 101 may display a monitoring interface on the display 1012 of the monitoring device 101. The monitoring interface may include a map of the photovoltaic power station. That is, the map of the photovoltaic power station may be displayed on the display 1012 of the monitoring device 101. The map includes the identification c of at least one photovoltaic device. The identification of the photovoltaic device may be at least one of the name, type and icon of the photovoltaic device. The identification of the photovoltaic device may be pre-configured by the monitoring device 101, or may be set by the monitoring engineer, which is not limited in embodiments of the present disclosure. In the case that the identification of the photovoltaic device is set by the monitoring engineer, the individuation and flexibility of the identification of the photovoltaic device may be improved. For the convenience of description, the embodiments of the present disclosure take the identifications as icons as examples. For example, FIG. 6 shows the icons of four photovoltaic devices. In addition, “XXX” in FIG. 6 indicates the name of the photovoltaic power station. In this way, the monitoring engineer may observe the distribution of the devices of the photovoltaic power station more intuitively.

In some embodiments, referring to FIG. 7, different types of photovoltaic devices may use different icons, such that the monitoring engineer may identify the photovoltaic devices according to the icons. The types of the photovoltaic devices include: booster station, box-type substation, inverter, combiner box, and string.

Referring to FIG. 6, in addition to the map of the photovoltaic power station, the monitoring interface may also include a navigation bar. The navigation bar may include a plurality of buttons, wherein each of the buttons may include at least one drop-down menu button. In an example, in FIG. 6, the buttons in the navigation bar include: centralized control center, alarm information, power station information, comprehensive report, data export, analysis tool, custom report, and power station management. The drop-down menu buttons for the power station information include: power station monitoring, device distribution, and device monitoring. FIG. 6 is a schematic diagram of a device distribution interface according to embodiments of the present disclosure.

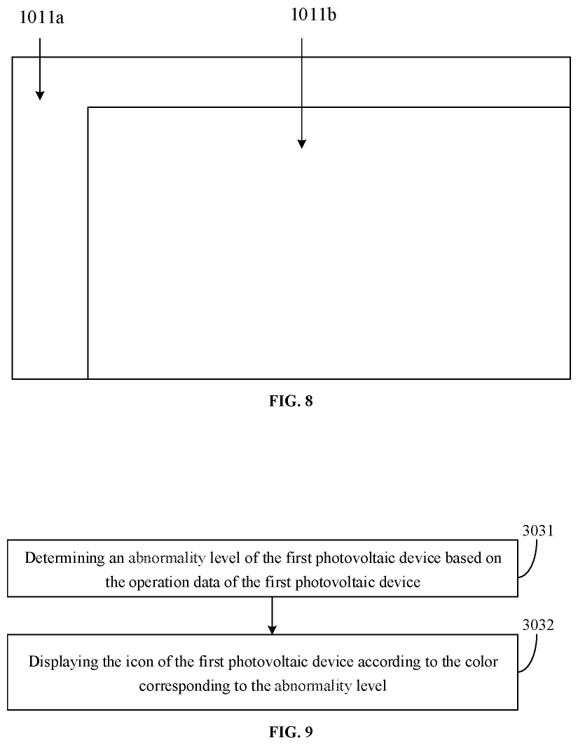

Referring to FIG. 8, the display 1012 of the monitoring device 101 has a first display area 1011a and a second display area 1011b. The first display area 1011a may be used to display the navigation bar, and the second display area 1011b may be configured to display the map of the photovoltaic power station. That is, the map of the photovoltaic power station does not occupy the entire display area of the display 1012.

In the embodiments of the present disclosure, the monitoring device 101 may display the map of the photovoltaic power station according to an initial scaling. Moreover, in the case that the monitoring device 101 displays the map of the photovoltaic power station according to the initial scaling, the display 1012 may display the entire area of the photovoltaic power station. The initial scaling may be pre-stored in the monitoring device 101.

The initial scaling may be determined based on the distance between two photovoltaic devices of the photovoltaic power station farthest away from each other and the resolution (also referred to as display resolution) of the second display area 1011b of the display 1012 of the monitoring device 101. The initial scaling is positively related to the distance between the two photovoltaic devices farthest away from each other, and negatively related to the resolution of the second display area 1011b. That is, the larger the distance between the two photovoltaic devices farthest away from each other and the smaller the resolution of the second display area 1011b, the larger the initial scaling; the smaller the distance between the two photovoltaic devices farthest away from each other and the larger the resolution of the second display area 1011b, the smaller the initial scaling.

Since the large number of photovoltaic devices are included in the photovoltaic power station, in the case that the display 1012 of the monitoring device 101 displays the map of the photovoltaic power station (for example, displays the map of the photovoltaic power station according to the initial scaling), the identification of each of the photovoltaic devices in the photovoltaic power station may not be displayed. Thereby, the display 1012 of the monitoring device 101 may display the background of the photovoltaic power station and display the identification of at least one photovoltaic device on the background.

The displayed identification of at least one photovoltaic device may be an identification of a photovoltaic device with a level higher than the level threshold. The level of the photovoltaic device being higher than the level threshold may mean that the level of the device group to which the photovoltaic device belongs is higher than the level threshold. In an example, the level of the first device group 401 and the level of the second device group 402 are both higher than the level threshold, and both the photovoltaic devices included in the first device group 401 and the photovoltaic devices included in the second device group are the photovoltaic devices with levels higher than the level threshold. None of the level of the third device group 403, the level of the fourth device group 404 and the level of the fifth device group 405 is higher than the level threshold, the photovoltaic devices included in the third device group 403, the photovoltaic devices included in the fourth device group 404, and the photovoltaic devices included in the fifth device group 405 are not the photovoltaic devices with levels higher than the level threshold.

In step 303, the monitoring device displays an identification of a first photovoltaic device according to a first display effect in response to determining, based on the operation data of the first photovoltaic device, that the first photovoltaic device operates abnormally.

In the embodiments of the present disclosure, the monitoring device 101 may pre-store threshold ranges each corresponding to one operation indicator. For each operation indicator of each photovoltaic device, the monitoring device 101 may determine, based on the acquired data of the operation indicator and the pre-stored threshold range of the operation indicator, whether the data of the operation indicator of the photovoltaic device is within the threshold range. In the case that the data of each of the plurality of operation indicators is within the corresponding threshold range, the monitoring device 101 may determine that the operation data of the photovoltaic device is normal, and further determine that the photovoltaic device operates normally. In the case that data of an operation indicator of the plurality of operation indicators is not within the corresponding threshold range, the monitoring device 101 may determine that the operation data of the photovoltaic device is abnormal, and further determine that the photovoltaic device operates abnormally.

In an example, assuming that the device power of a photovoltaic device does not change within a time threshold range, then the monitoring device 101 may determine that the device power of the photovoltaic device is abnormal. Assuming that the temperature of a photovoltaic device is higher than a temperature threshold (for example, the temperature threshold is 70 degrees Celsius), then the monitoring device 101 may determine that the temperature of the photovoltaic device is abnormal.

In the case that the monitoring device 101 determines, based on the operation data of the first photovoltaic device, that the first photovoltaic device operates abnormally, the monitoring device 101 may display the updated map of the photovoltaic power station. The updated map may include the identification of the first photovoltaic device, and the identification of the first photovoltaic device is displayed according to the first display effect. The first display effect is different from the second display effect of the identifications of other normal photovoltaic devices. In addition, the updated map may also include the identification of the photovoltaic device with a level higher than the level threshold.

In the case that a large number of photovoltaic devices in the plurality of photovoltaic devices operate abnormally, the updated map displayed by the monitoring device 101 may only include the identification of the first photovoltaic device. In the case that no photovoltaic device in the plurality of photovoltaic devices operates abnormally, the updated map displayed by the monitoring device 101 may only include identifications of at least some photovoltaic devices with a level higher than the level threshold. In the case that a small number of photovoltaic devices in the plurality of photovoltaic devices operate abnormally, the updated map displayed by the monitoring device 101 may include the identification of the first photovoltaic device and the identifications of at least some photovoltaic devices with a level higher than the level threshold.

Referring to FIG. 9, the process of displaying the identification of the first photovoltaic device by the monitoring device 101 according to the first display effect may include the following steps.

In step 3031, the monitoring device determines the abnormality level of the first photovoltaic device based on the operation data of the first photovoltaic device.

In the embodiments of the present disclosure, the abnormality level of the first photovoltaic device may indicate a fault and a warning. The level of fault is higher than the level of warning. Different abnormality levels of the first photovoltaic device have different influences on the photovoltaic power station. In the case that the abnormality level of the first photovoltaic device indicates a fault, which indicates that the first photovoltaic device has a great influence on the photovoltaic power station, the first photovoltaic device may need to be overhauled immediately. In the case that the abnormality level of the first photovoltaic device indicates a warning, indicating that the first photovoltaic device has little influence on the photovoltaic power station, the first photovoltaic device does not need to be overhauled immediately.

In step 3032, the monitoring device displays the identification of the first photovoltaic device according to the color corresponding to the abnormality level.

In the embodiments of the present disclosure, the monitoring device 101 may display the identification of the first photovoltaic device according to the color corresponding to the abnormality level. Different colors correspond to different abnormality levels, such that the monitoring engineer may judge the abnormality level of the first photovoltaic device according to the color of the identification.

In some embodiments, in the case that the abnormality level of the first photovoltaic device indicates a fault, the color of the displayed identification of the first photovoltaic device may be red. In addition, in order to enhance the prompting effect to the monitoring engineer, a red aperture may also be flashed and displayed at the periphery of the identification of the first photovoltaic device. In the case that the abnormality level of the first photovoltaic device indicates a warning, the color of the displayed identification of the first photovoltaic device may be yellow.

In step 304, the monitoring device displays the alarm information for the first photovoltaic device and the identification of each of second photovoltaic devices associated with the first photovoltaic device in response to the select operation with respect to the identification of the first photovoltaic device.

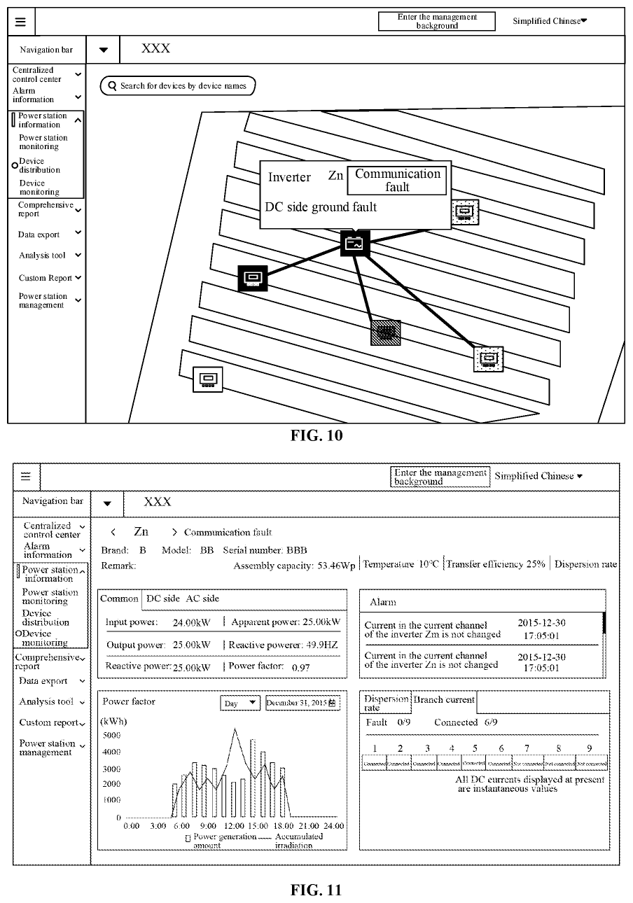

In the embodiments of the present disclosure, the monitoring device 101 displays the identification of the first photovoltaic device according to the first display effect, indicating that the operation data of the first photovoltaic device is abnormal. In this case, the monitoring engineer may trigger the select operation with respect to the identification of the first photovoltaic device. Referring to FIG. 10, upon receiving the select operation with respect to the identification of the first photovoltaic device, the monitoring device 101 may display alarm information for the first photovoltaic device, and display the identification of each of second photovoltaic devices associated with the first photovoltaic device. The alarm information includes abnormal operation data of the first photovoltaic device.

The second photovoltaic device associated with the first photovoltaic device may be a photovoltaic device connected to the first photovoltaic device in a device group at the next level of the device group to which the first photovoltaic device belongs. For example, assuming that the first photovoltaic device is an inverter and the device group to which the inverter belongs is the third device group 403, then the second photovoltaic device associated with the first photovoltaic device is the combiner box in the fourth device group 404 connected to the inverter.

In addition, in the case that the display 1012 of the monitoring device 101 displays the identification of the first photovoltaic device and the identification of each of the second photovoltaic devices, a connection line between the identification of the first photovoltaic device and the identification of each second photovoltaic device may also be displayed. Each of the connection lines indicates that the first photovoltaic device is connected to the second photovoltaic device, such that it is convenient for the monitoring engineer to distinguish which photovoltaic devices are connected to the first photovoltaic device.

For each second photovoltaic device, in the case that the monitoring device 101 displays the identification of the second photovoltaic device, the identification of the second photovoltaic device may be displayed according to the operation of the second photovoltaic device. For example, in the case that the operation data of the second photovoltaic device is abnormal, and the abnormality level of the second photovoltaic device indicates a fault, the displayed color of the identification of the second photovoltaic device may be red, and the red aperture may be flashed and displayed at the periphery of the identification of the second photovoltaic device. In the case that the operation data of the second photovoltaic device is abnormal, and the abnormality level of the second photovoltaic device indicates a warning, the color of the displayed identification of the second photovoltaic device may be yellow. In the case that the second photovoltaic device operates normally, the second photovoltaic device is displayed according to the second display effect, for example, the color of the displayed identification of the second photovoltaic device is green. In FIG. 10, filling with black indicates that the color of the identification is red, filling with gray indicates that the color of the identification is yellow, and filling with black dots indicates that the color of the identification is green.

In this way, by displaying the identification of each of the second photovoltaic devices associated with the first photovoltaic device, the monitoring engineer may more intuitively observe the operation status of the devices of the photovoltaic power station.

In the embodiments of the present disclosure, the step of displaying the identification of each of the second photovoltaic devices associated with the first photovoltaic device may include: displaying the target area in the map according to the target scaling. The target area may include the identification of the first photovoltaic device and the identification of each second photovoltaic device. It should be noted that, in step 302, the displayed map of the photovoltaic power station may include the identification of the first photovoltaic device, or may not include the identification of the first photovoltaic device; but in step 304, the displayed target area of the map needs to include the identification of the first photovoltaic device, so as to achieve the highlighted display of the identification of the first photovoltaic device.

The target scaling may be acquired in a plurality of ways. The two following acquisition ways are taken as examples for illustration in the embodiments of the present disclosure.

In the first optional acquisition way, the monitoring device 101 may pre-store the corresponding relationship between the photovoltaic device and the scaling. The monitoring device 101 may directly determine the scaling of the first photovoltaic device in the corresponding relationship as the target scaling.

In the corresponding relationship, for any photovoltaic device, the corresponding scaling may be determined based on the distance between the any photovoltaic device and each associated photovoltaic device and the resolution of the display 1012 of the monitoring device 101. Also, the scaling is positively related to distance and negatively related to resolution. For the determination process of each scaling in the corresponding relationship, reference may be made to the subsequent second optional acquisition way, in process of which the target scaling of the first photovoltaic device is determined based on the distance between the first photovoltaic device and each second photovoltaic device and the resolution of the display 1012 of the monitoring device 101.

In the second optional acquisition way, the monitoring device 101 may not store the corresponding relationship between the photovoltaic device and the scaling. The monitoring device 101 may directly determine the target scaling of the first photovoltaic device according to the distance between the first photovoltaic device and each second photovoltaic device and the resolution of the display 1012 of the monitoring device 101.

Since the area of the display 1012 for displaying the map of the photovoltaic power station is the second display area 1011b, the target scaling may be determined based on the distance between the first photovoltaic device and each second photovoltaic device and the resolution of the second display area 1011b. In an example, the process of determining the target scaling includes the following steps.

In A1, the distance between the first photovoltaic device and the second photovoltaic device is determined.

In embodiments of the present disclosure, the monitoring device 101 may pre-store the latitude and longitude of each photovoltaic device in the photovoltaic power station. For each second photovoltaic device, the monitoring device 101 may determine the distance between the first photovoltaic device and the second photovoltaic device based on the latitude and longitude of the first photovoltaic device and the latitude and longitude of the second photovoltaic device. That is, the monitoring device 101 may determine the distance between the first photovoltaic device and each of the second photovoltaic devices.

In some embodiments, the distance d between the first photovoltaic device and the second photovoltaic device satisfies:

d=R×arccos[sin Y1×sin Y2+cos X1×cos X2×cos(X1−X2)] Formula (1)

In formula (1), R is the radius of the earth, Y1 is the longitude of the first photovoltaic device, Y2 is the longitude of the second photovoltaic device, X1 is the latitude of the first photovoltaic device, and X2 is the latitude of the second photovoltaic device.

In A2, the resolution of the second display area is acquired.

Normally, the second display area is a fixed area in the display 1012, so its resolution is known. The monitoring device 101 may directly acquire the resolution of the second display area 1011b.

In A3, the target scaling is determined based on the distance between the first photovoltaic device and each of the second photovoltaic devices and the resolution of the second display area.

In the embodiments of the present disclosure, in order to enable the identification of each second photovoltaic device to be displayed on the display 1012, the target scaling may be determined based on the maximum distance determined by the monitoring device 101 (the maximum distance is the distance between the first photovoltaic device and the second photovoltaic device farthest from the first photovoltaic device) and the resolution of the second display area 1011b. In response to the select operation with respect to the identification of the first photovoltaic device, the monitoring device 101 may display the identification of the first photovoltaic device in the center of the second display area 1011b. Therefore, the second photovoltaic device farthest from the first photovoltaic device may occupy at most ¼ of the area of the second display area 1011b.

Assuming that the resolution of the second display area 1011b is M×N, then the first photovoltaic device and the second photovoltaic device farthest from the first photovoltaic device may at most occupy an area of M/4×N/4. Thus, the monitoring device 101 may calculate that the farthest pixel distance S in the area of M/4×N/4 satisfies:

S=\sqrt{(M/4)²+(N/4)²} Formula (2)

In the embodiments of the present disclosure, referring to Table 1, the monitoring device 101 may pre-store the corresponding relationship between a plurality of actual distances and the number of pixels that may be occupied by each actual distance, and then may determine the actual distance corresponding to one pixel. The actual distance corresponding to one pixel may be called the scaling.

TABLE 1

| | Actual distance | Number | |
|---|---|---|---|
| No. | (km) | of pixels | Scaling |
| 1 | 5000 | 70 | 71.4286 |
| 2 | 2000 | 55 | 36.3636 |
| 3 | 2000 | 115 | 17.3913 |
| 4 | 1000 | 115 | 8.6957 |
| 5 | 500 | 115 | 4.3478 |
| 6 | 200 | 91 | 2.1978 |
| 7 | 100 | 176 | 0.5682 |
| 8 | 50 | 91 | 0.5495 |
| 9 | 20 | 72 | 0.2778 |
| 10 | 20 | 72 | 0.1389 |
| 11 | 5 | 72 | 0.0694 |
| 12 | 2 | 57 | 0.0351 |
| 13 | 2 | 118 | 0.0169 |
| 14 | 1 | 118 | 0.0085 |
| 15 | 0.5 | 118 | 0.0042 |
| 16 | 0.2 | 93 | 0.0022 |
| 17 | 0.1 | 93 | 0.0011 |
| 18 | 0.05 | 93 | 0.0005 |
| 19 | 0.02 | 74 | 0.0003 |

As listed in Table 1, the monitoring device 101 stores 19 actual distances, and the number of pixels which may be occupied by each actual distance. For example, the actual distance of No. 1 is 5000 km, the number of pixels that may be occupied is 70, and the actual distance (i.e., the scaling) corresponding to one pixel is 71.4286 km.

The monitoring device 101 determines the distance between the first photovoltaic device and each second photovoltaic device according to formula (1), and acquires a plurality of distances. Afterwards, the monitoring device 101 may determine the maximum distance dmax from the plurality of distances, and calculate the ratio of the maximum distance dmax to the farthest pixel distance S. Then, the monitoring device 101 may determine, according to the determined ratio and the scalings in Table 1, which two adjacent scalings the ratio lies between. After that, the larger one of the two scalings is determined as the target scaling.

In an example, assuming that the monitoring device 101 calculates that the ratio of the maximum distance dmax to the farthest pixel distance S is 50, the monitoring device 101 may determine that the ratio lies between the scaling of No. 1 (71.4286) and the scaling of No. 2 (36.3636). Therefore, the monitoring device 101 may directly determine the scaling (71.4286) as the target scaling.

It should be noted that the disconnection of the connection lines between the photovoltaic devices included in the device group may lead to interruption of the communication between the photovoltaic devices in the photovoltaic power station. In the case that each photovoltaic device (box-type substation) in the device group at the next level of the device group to which a photovoltaic device (booster station) belongs is out of service, the monitoring device 101 may display the connection lines in red, which means that the connection lines are faulty or disconnected and need to be overhauled immediately. In the case that some photovoltaic devices (box-type substations) in the device group at the next-level of the device group to which a photovoltaic device (booster station) belongs are out of service, the monitoring device 101 may display the connection lines in yellow, and the photovoltaic devices out of service needs to be overhauled.

In step 305, the monitoring device displays the identification of the third photovoltaic device according to the third display effect in response to the select operation with respect to the identification of the first photovoltaic device.

In the embodiments of the present disclosure, upon receiving the select operation with respect to the first photovoltaic device, the monitoring device 101 may display the identification of the third photovoltaic device according to the third display effect in response to the selection operation of the identification of the first photovoltaic device. The third display effect is different from the first display effect and the second display effect. The third photovoltaic device is a photovoltaic device in the plurality of photovoltaic devices other than the first photovoltaic device and the second photovoltaic device.

In the case that the monitoring device 101 receives the select operation with respect to the first photovoltaic device, the display 1012 of the monitoring device 101 not only may display the identification of the first photovoltaic device and the identification of the second photovoltaic device, but also may display the identification of the third photovoltaic device. In addition, since the monitoring engineer mainly focuses on the first photovoltaic device and the second photovoltaic device in this case, the third display effect is used to display the identification of the third photovoltaic device, such that the monitoring engineer may distinguish the first photovoltaic device, the second photovoltaic device, and the third photovoltaic device.

In some embodiments, the color of the identification of the third photovoltaic device displayed on the display 1012 of the monitoring device 101 may be gray. In FIG. 10, filling with white indicates that the color of the identification is gray.

In step 306, the monitoring device sends the operation and maintenance information to the operation and maintenance terminal in response to the acknowledge operation with respect to the prompt information.

In the embodiments of the present disclosure, upon observing, over the display 1012 of the monitoring device 101, that the display effect of the first photovoltaic device is the first display effect, the monitoring engineer may know that the first photovoltaic device may be faulty currently. In order to confirm whether the first photovoltaic device is faulty, the monitoring engineer may trigger a click operation on the prompt information. Referring to FIG. 11, upon receiving the click operation, the monitoring device 101 may display the operation data of the first photovoltaic device on the display 1012 of the monitoring device 101. The monitoring engineer may further judge that, according to the operation data of the first photovoltaic device, whether the abnormal operation data of the first photovoltaic device is caused by the fault of the first photovoltaic device.

Referring to FIG. 11, the monitoring interface may display: the device name of the first photovoltaic device: Zn; operation status: communication fault, brand: B; model: BB; serial number: BBB; assembly capacity: 53.46 (peak total power, kWp); temperature: 10 degrees Celsius (° C.); transfer efficiency: 99.25%; dispersion rate; input power: 24.00 kilowatts (kW); output power: 25.00 kW; reactive power: 25.00 kW; apparent power: 25.00 kW; grid frequency: 49.97 hertz (Hz); power factor: 0.97; power generation amount; alarm information list; and branch current information.

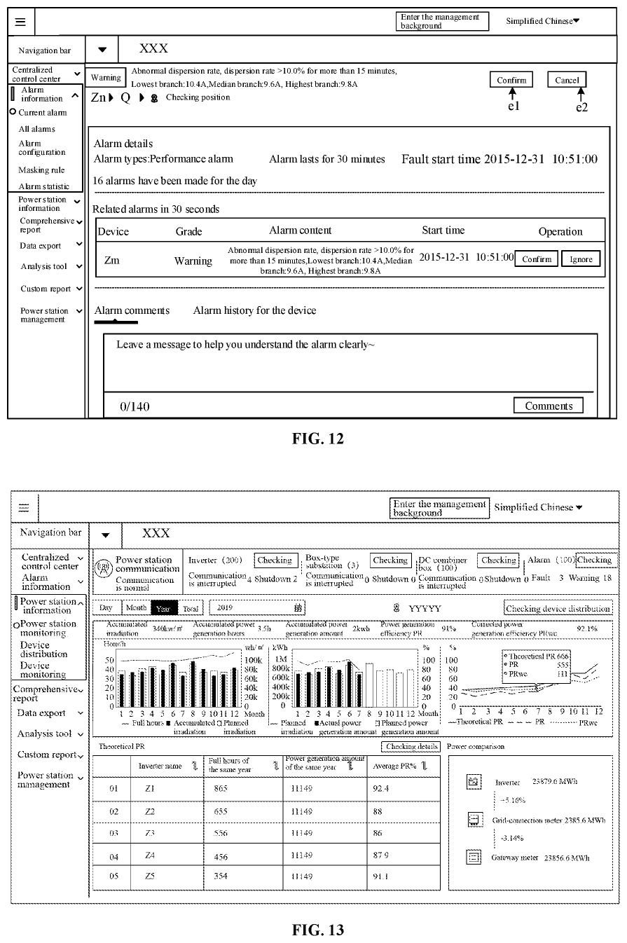

The monitoring engineer may trigger a click operation on the area where the latest alarm information in the alarm information list is located. The monitoring device 101 may display an alarm interface in response to the click operation. Referring to FIG. 12, the alarm interface includes device serial number, alarm content, abnormality level, start alarm time, alarm duration, alarm times of the day, confirmation button e1, and cancel button e2.

In response to judging that the abnormal operation data of the first photovoltaic device is caused by the fault of the first photovoltaic device, the monitoring engineer may trigger a click operation on the confirmation button e1. Upon receiving the click operation on the confirmation button e1, the monitoring device 101 may send the operation and maintenance information to the operation and maintenance terminal 102. Thus, the operation and maintenance engineer may review the operation and maintenance information sent by the monitoring device 101 over the operation and maintenance terminal 102, and the operation and maintenance engineer may perform overhaul on the first photovoltaic device according to the operation and maintenance information. The operation and maintenance information may be an operation and maintenance work order.

In response to judging that the abnormal operation data of the first photovoltaic device is not caused by the fault of the first photovoltaic device, the monitoring engineer may trigger a click operation on the cancel button e2. Upon receiving the click operation on the cancel button e2, the monitoring device 101 may determine that it is not necessary to send the operation and maintenance information to the operation and maintenance terminal 102. That is, the monitoring device 101 may ignore the prompt information of the first photovoltaic device.

In an example, it is assumed that the monitoring device 101 of the photovoltaic power station determines that the operation data of one first photovoltaic device (inverter) is abnormal at 14:01 pm, then the color of the identification of the first photovoltaic device is red, but at this time, the monitoring engineer may not judge whether the abnormal operation data of the first photovoltaic device is caused by the fault of the first photovoltaic device or is caused by the fault of a second photovoltaic device (combiner box) associated with the first photovoltaic device. Thus, the monitoring engineer may trigger a select operation with respect to the identification of the first photovoltaic device, and upon receiving the selection operation, the monitoring device 101 displays the identification of each second photovoltaic device associated with the first photovoltaic device. Assuming that the display effect of a second photovoltaic device is the first display effect, the monitoring engineer may check the operation data of the second photovoltaic device. In response to judging that the abnormal operation data of the first photovoltaic device is caused by the abnormal operation of the second photovoltaic device, the monitoring engineer may trigger the click operation on the confirmation button e1 in the alarm interface of the second photovoltaic device. Upon receiving the click operation on the confirmation button e1 in the alarm interface for the second photovoltaic device, the monitoring device 101 may send the operation and maintenance information to the operation and maintenance terminal 102, the operation and maintenance information is a prompt to overhaul the second photovoltaic device.

It is assumed that the monitoring device 101 of the photovoltaic power station determines that the dispersion rate of a combiner box is higher at 12:32 pm, then the monitoring engineer determines in combination with the satellite imagery that the combiner box is blocked by the shadow of a building. The monitoring engineer may determine that the higher dispersion rate of the combiner box is not caused by the fault of the combiner box. In this case, the monitoring engineer may trigger the click operation on the cancel button e2 in the alarm interface for the combiner box. Upon receiving the click operation on the cancel button e2 in the alarm interface for the combiner box, the monitoring device 101 ignores the prompt information with respect to the combiner box.

FIG. 13 is a schematic diagram of a power station monitoring interface according to some embodiments of the present disclosure. Referring to FIG. 13, the power station monitoring interface includes: the communication status of the power station: communication is normal; the inverter status (including 200 inverters in total, wherein 4 inverters are in communication with the terminals, and 2 inverters are out of service), DC combiner box filling (including 100 DC combiner boxes in total, wherein no DC combiner box is in communication with the terminals, and no DC combiner box is out of communication service); alarm status (120 alarms in total, with 3 faults and 18 warnings); accumulated irradiation: 340 kilowatts/square meter (kw/m²); accumulated power generation hours: 3.5 hours (h); accumulated power generation amount: 2 kilowatt hours (kwh); power generation efficiency PR: 91%; corrected power generation efficiency PRwc: 92.1%; inverter chart; and power comparison. The monitoring engineer may comprehensively grasp the working status of the photovoltaic power station over the power station monitoring interface.

In step 307, in response to determining, based on the reacquired operation data of the first photovoltaic device, that the first photovoltaic device resumes normal operation, the monitoring device adjust the display effect of the identification of the first photovoltaic device to the second display effect.

In the embodiments of the present disclosure, in the case that the operation and maintenance terminal 102 receives the operation and maintenance information sent by the monitoring device 101, the operation and maintenance engineer may review the operation and maintenance information over the operation and maintenance terminal 102. The operation and maintenance information may carry the device name, alarm information, address of the first photovoltaic device, and the like. The operation and maintenance engineer may quickly find the first photovoltaic device over the navigation client installed in the operation and maintenance terminal 102 according to the device name and address of the first photovoltaic device carried in the operation and maintenance information. In addition, the operation and maintenance engineer may overhaul the first photovoltaic device according to the alarm information of the first photovoltaic device carried in the operation and maintenance information.

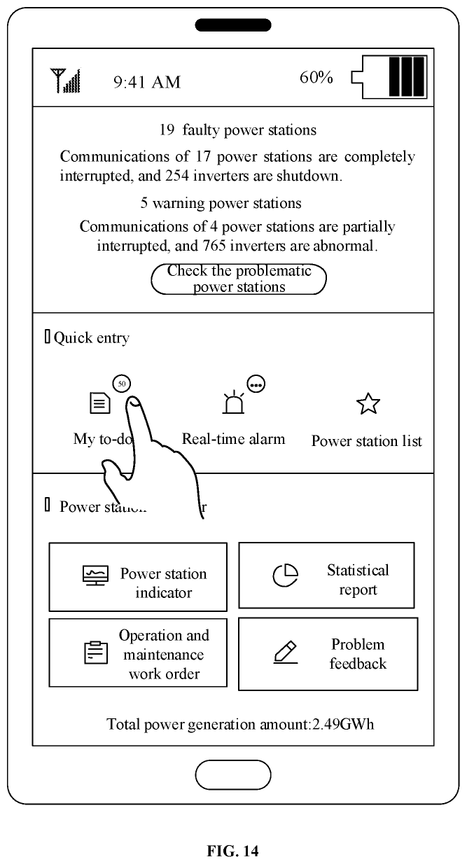

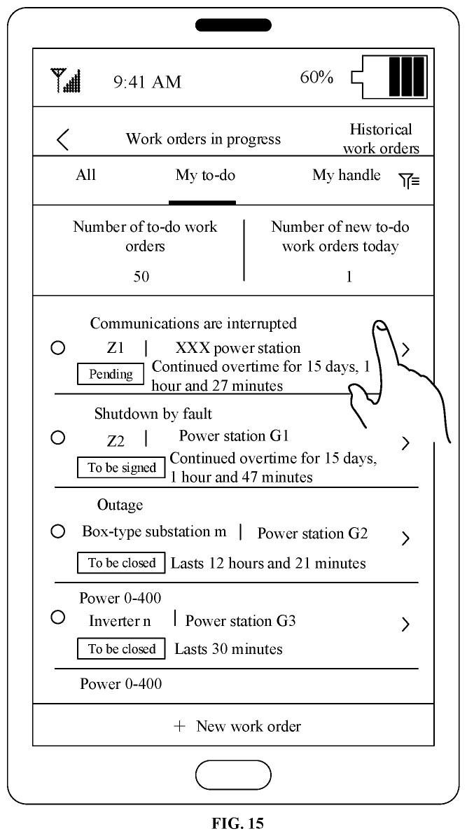

FIG. 14 is a schematic diagram of an operation and maintenance interface of an operation and maintenance terminal according to some embodiments of the present disclosure. Referring to FIG. 14, the operation and maintenance interface may include buttons, such as the number of faulty power stations (19), the number of warning power stations (4), my to-do, real-time alarm, power station list, power station indicators, statistical report, operation and maintenance information, problem feedback, and the like. The operation and maintenance interface in FIG. 14 also displays that the total power generation amount of the power station is 219 million watt-hours (GWh).

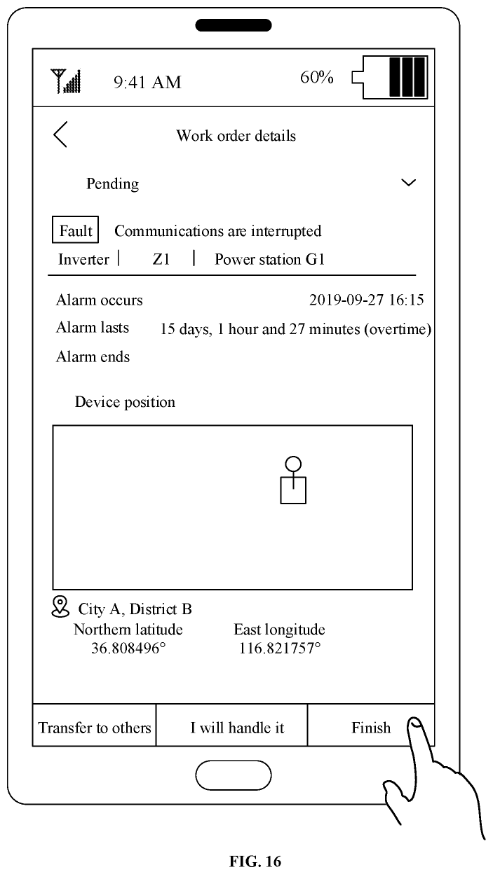

The operation and maintenance engineer may trigger a click operation on the to-do button, and the operation and maintenance terminal 102 may display the to-do list upon receiving the click operation on the to-do button. Referring to FIG. 15, the to-do list includes device names and alarm information of a plurality of photovoltaic devices to be overhauled. Referring to FIG. 16, upon triggering a click operation on the area where the device name of the first photovoltaic device is located, the operation and maintenance terminal 102 may display the position and the alarm duration of the first photovoltaic device. The operation and maintenance engineer may quickly find, based on the position of the first photovoltaic device displayed in the operation and maintenance terminal 102, the first photovoltaic device over the navigation client installed in the operation and maintenance terminal 102, and overhaul the first photovoltaic device.

Referring to FIG. 16, the operation and maintenance interface further includes a completion button, and the operation and maintenance engineer may trigger a click operation on the completion button upon completion of overhaul of the first photovoltaic device. Upon receiving the click operation for the completion button, the operation and maintenance terminal 102 may send an overhaul completion information for the first photovoltaic device to the monitoring device 101. The overhaul completion information may be used to indicate completion of overhaul of the first photovoltaic device. Upon receiving the overhaul completion information for the first photovoltaic device, the monitoring device 101 may determine, based on the reacquired operation data of the first photovoltaic device, whether the operation data of the first photovoltaic device is normal, and further determine whether the first photovoltaic device resumes normal operation.

In response to determining, based on the operation data of the first photovoltaic device, that the first photovoltaic device resumes normal operation, the monitoring device 101 may adjust the display effect of the identification of the first photovoltaic device to the second display effect (for example, the color of the identification of the first photovoltaic device is adjusted to green). In the case that it is determined, based on the reacquired operation data of the first photovoltaic device, that the first photovoltaic device does not resume normal operation, steps 301 to 307 may be performed again.

It should be noted that, the sequence of steps of the method for monitoring the photovoltaic power station according to the embodiments of the present disclosure may be adjusted appropriately, and the steps may also be increased or decreased according to actual situations. For example, step 302 may be performed upon step 303 (that is, it is first determined that an abnormal photovoltaic device is present in the plurality of photovoltaic devices, and then the map of the photovoltaic power station is displayed), or steps 305 and 307 may be canceled according to situations, or steps 304 and 305 may be performed synchronously, or step 301 may be performed synchronously with any of steps 302 to 307. Any person familiar with the technical field may easily conceive varied methods within the technical scope disclosed by the present disclosure, which should be covered within the protection scope of the present disclosure, and therefore is not repeated herein.

In summary, the embodiments of the present disclosure provide a method for monitoring a photovoltaic power station. The device for monitoring the photovoltaic power station may display the prompt information with respect to the first photovoltaic device on the display of the monitoring device in response to determining, based on the operation data of the first photovoltaic device, that the first photovoltaic device operates abnormally. Therefore, the monitoring engineer may timely judge, based on the prompt information, whether the first photovoltaic device is faulty, which is convenient for the monitoring engineer to guide the subsequent operation and maintenance according to the operation data of the photovoltaic device, which not only has better flexibility, but also ensures the efficiency of fault detection. Moreover, since the monitoring device may also send the operation and maintenance information to the operation and maintenance terminal in response to detecting the acknowledge operation with respect to the prompt information, the overhaul efficiency of the faulty photovoltaic device may be effectively improved.

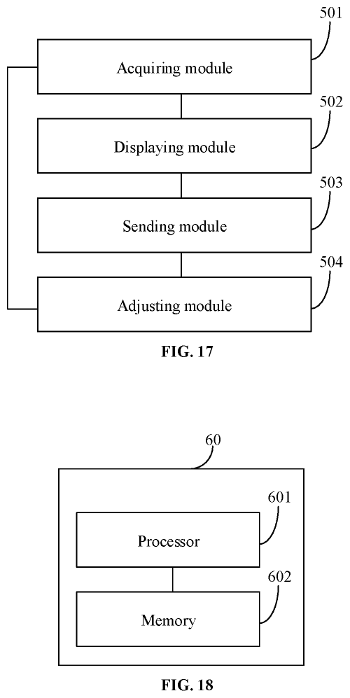

FIG. 17 is a schematic structural diagram of a monitoring device 101 for monitoring a photovoltaic power station according to some embodiments of the present disclosure. Referring to FIG. 17, the monitoring device 101 may include:
an acquiring module 501, configured to acquire the operation data of each of the plurality of photovoltaic devices included in the photovoltaic power station;
a displaying module 502, configured to display prompt information with respect to the first photovoltaic device in response to determining, based on the operation data of the first photovoltaic device, that the first photovoltaic device operates abnormally;
a sending module 503, configured to send the operation and maintenance information to the operation and maintenance terminal in response to the acknowledge operation with respect to the prompt information, wherein the operation and maintenance information is a prompt to overhaul the first photovoltaic device.

In some embodiments, the displaying module 502 may be configured to display the identification of the first photovoltaic device according to the first display effect in response to determining, based on the operation data of the first photovoltaic device, that the first photovoltaic device operates abnormally. The first display effect is different from the second display effect of the identifications of other normal photovoltaic devices.

In some embodiments, the displaying module 502 is further configured to, in response to a select operation with respect to the identification of the first photovoltaic device, display alarm information for the first photovoltaic device, and display the identification of each of second photovoltaic devices associated with the first photovoltaic device. The alarm information includes abnormal display data of the first photovoltaic device.

In some embodiments, the displaying module 502 is further configured to display a map of the photovoltaic power station. The map includes the identification of at least one photovoltaic device. The target area in the map is displayed according to the target scaling.

The target area includes the identification of the first photovoltaic device and the identification of each of the second photovoltaic devices. The target scaling determines the target scaling based on the distance between the first photovoltaic device and each of the second photovoltaic devices and the resolution of the display 1012 of the monitoring device 101. The target scaling is positively related to the distance and negatively related to the resolution.

In some embodiments, the plurality of photovoltaic devices are divided into a plurality of device groups of different levels. Each device group includes one photovoltaic device or a plurality of photovoltaic devices of the same level. The displaying module 502 is further configured to display the map of the photovoltaic power station according to the initial scaling. The map includes the identification of at least one of the first photovoltaic device and a photovoltaic device with a level higher than a level threshold.

In some embodiments, the displaying module 502 is further configured to: determine the abnormality level of the first photovoltaic device based on the operation data of the first photovoltaic device; and display the identification of the first photovoltaic device according to the color corresponding to the abnormality level. Different colors correspond to different abnormality levels.

The displaying module 502 is further configured to display the identification of the third photovoltaic device according to the third display effect in response to the select operation with respect to the identification of the first photovoltaic device. The third display effect is different from the first display effect and the second display effect, and the third photovoltaic device is a photovoltaic device in the plurality of photovoltaic devices other than the first photovoltaic device and the second photovoltaic device.

Referring to FIG. 17, the monitoring device 101 may further include an adjusting module 504. The adjusting module 504 is configured to adjust the display effect of the identification of the first photovoltaic device to the second display effect in response to determining, based on the reacquired operation data of the first photovoltaic device, that the first photovoltaic device resumes normal operation.

In summary, the embodiments of the present disclosure provide a device for monitoring a photovoltaic power station. The monitoring device may display the prompt information with respect to the first photovoltaic device on the display of the monitoring device in response to determining, based on the operation data of the first photovoltaic device, that the first photovoltaic device operates abnormally. Therefore, the monitoring engineer may timely judge, based on the prompt information, whether the first photovoltaic device is faulty, which is convenient for the monitoring engineer to guide the subsequent operation and maintenance based on the operation data of the photovoltaic device, which not only has better flexibility, but also ensures the efficiency of fault detection. Moreover, since the monitoring device may also send the operation and maintenance information to the operation and maintenance terminal in response to detecting the acknowledge operation with respect to the prompt information, the overhaul efficiency of the faulty photovoltaic device may be effectively improved.

Those skilled in the art may clearly understand that, for the convenience and brevity of description, the specific working processes of various modules described above may refer to the corresponding processes in the foregoing method embodiments, which will not be repeated here.

FIG. 18 is a schematic structural diagram of another monitoring device 101 for monitoring a photovoltaic power station according to some embodiments of the present disclosure. Referring to FIG. 18, the monitoring device 101 may include a processor 601, a memory 602, and a computer program stored on the memory 602 and executable on the processor. The processor 601, when loading and executing the computer program, is caused to perform the method for monitoring the photovoltaic power station according to the above method embodiments, for example, the method shown in FIG. 2 or FIG. 3.

An embodiment of the present disclosure provides a computer-readable storage medium storing one or more instructions therein. The one or more instructions, when loaded and executed by a processor of a computer, causes the computer to perform the method for monitoring the photovoltaic power station according to the above method embodiments, for example, the method shown in FIG. 2 or FIG. 3.

An embodiment of the present disclosure provides a computer program product including one or more instructions therein. The computer program product, when running on a computer, causes the computer to perform the method for monitoring the photovoltaic power station according to the above method embodiments, for example, the method shown in FIG. 2 or FIG. 3.

Described above are merely exemplary embodiments of the present disclosure, and are not intended to limit the present disclosure. Any modifications, equivalent substitutions, improvements and the like are within the protection scope of the present disclosure, without departing from the spirit and principles of the present disclosure.

1. A method for monitoring a photovoltaic power station, applicable to a device for monitoring the photovoltaic power station, the photovoltaic power station comprising a plurality of photovoltaic devices;
the method comprising:
acquiring operation data of each of the plurality of photovoltaic devices;
displaying prompt information with respect to a first photovoltaic device in response to determining, based on the operation data of the first photovoltaic device, that the first photovoltaic device operates abnormally; and
sending operation and maintenance information to an operation and maintenance terminal in response to an acknowledge operation by a user confirming that the first photovoltaic device operates abnormally, wherein the operation and maintenance information is a prompt to overhaul the first photovoltaic device.

2. The method according to claim 1, wherein displaying the prompt information with respect to the first photovoltaic device in response to determining, based on the operation data of the first photovoltaic device, that the first photovoltaic device operates abnormally comprises:
displaying an identification of the first photovoltaic device according to a first display effect in response to determining, based on the operation data of the first photovoltaic device, that the first photovoltaic device operates abnormally;
wherein the first display effect is different from a second display effect of identifications of other normal photovoltaic devices.

3. The method according to claim 2, wherein upon displaying the identification of the first photovoltaic device according to the first display effect, the method further comprises:
displaying alarm information for the first photovoltaic device, and displaying an identification of each of second photovoltaic devices connected to the first photovoltaic device, in response to a select operation with respect to the identification of the first photovoltaic device, wherein the alarm information comprises abnormal operation data of the first photovoltaic device.

4. The method according to claim 3, wherein
prior to displaying the prompt information with respect to the first photovoltaic device, the method further comprises:
displaying a map of the photovoltaic power station, wherein the map comprises identification of at least one of the photovoltaic devices; and
displaying the identification of each of the second photovoltaic devices associated with the first photovoltaic device comprises:
displaying a target area in the map according to a target scaling, wherein the target area comprises an identification of the first photovoltaic device and an identification of each of the second photovoltaic devices, wherein the target scaling is determined based on a distance between the first photovoltaic device and each of the second photovoltaic devices and a resolution of a display of the device for monitoring the photovoltaic power station, and the target scaling is positively related to the distance and negatively related to the resolution.

5. The method according to claim 4, wherein
the plurality of photovoltaic devices are connected in a tree structure having a plurality of levels, each level comprising one photovoltaic device or a plurality of photovoltaic devices; and
displaying the map of the photovoltaic power station comprises:
displaying the map of the photovoltaic power station according to an initial scaling, wherein the map comprises identification of at least one of the first photovoltaic device and a photovoltaic device at a level higher than a level threshold.

6. The method according to claim 2, wherein displaying the identification of the first photovoltaic device according to the first display effect comprises:
determining an abnormality level of the first photovoltaic device based on the operation data of the first photovoltaic device; and
displaying the identification of the first photovoltaic device according to a color corresponding to the abnormality level;
wherein different colors correspond to different abnormality levels.

7. The method according to claim 2, wherein upon displaying the prompt information with respect to the first photovoltaic device, the method further comprises:
adjusting a display effect of the identification of the first photovoltaic device to the second display effect in response to determining, based on reacquired operation data of the first photovoltaic device, that the first photovoltaic device resumes normal operation.

8. A device for monitoring a photovoltaic power station, the photovoltaic power station comprising a plurality of photovoltaic devices;
the device comprising:
an acquiring module, configured to acquire operation data of each of the plurality of photovoltaic devices;
a displaying module, configured to display prompt information with respect to a first photovoltaic device in response to determining, based on the operation data of the first photovoltaic device, that the first photovoltaic device operates abnormally; and
a sending module, configured to send operation and maintenance information to an operation and maintenance terminal in response to an acknowledge operation by a user confirming that the first photovoltaic device operates abnormally, wherein the operation and maintenance information is a prompt to overhaul the first photovoltaic device.

9. A system for monitoring a photovoltaic power station, comprising: an operation and maintenance device, and the device for monitoring the photovoltaic power station as defined in claim 8;
wherein the device for monitoring the photovoltaic power station is in communication with the operation and maintenance device.

10. A computer-readable storage medium storing one or more instructions therein, wherein the one or more instructions, when loaded and executed by a processor of a computer, cause the computer to perform the method for monitoring the photovoltaic power station as defined in claim 1.
